(19) United States
(12) Patent Application Publication
(10) Pub. No.: US 2005/0263298 A1
(43) Pub. Date: Dec. 1, 2005

(54) Hypoxic fire suppression system for aerospace applications

(76) Inventor: Igor K. Kotliar, New York, NY (US)

Correspondence Address: IGOR K. KOTLIAR, P.O. BOX 2021, NEW YORK, NY, 10159-2021, US

(21) Appl. No.: 11/183,948

(22) Filed: Jul. 19, 2005

Related U.S. Application Data
(63) Continuation-in-part of application No. 10/726,737, filed on Dec. 3, 2003.
(63) Continuation-in-part of application No. 09/551,026, filed on Apr. 17, 2000, now Pat. No. 6,314,754.
(63) Continuation-in-part of application No. 09/566,506, filed on May 8, 2000, now Pat. No. 6,334,315.
(63) Continuation-in-part of application No. 09/854,108, filed on May 11, 2001, now Pat. No. 6,401,487.
(63) Continuation-in-part of application No. 09/750,801, filed on Dec. 28, 2000, now Pat. No. 6,418,752.
(63) Continuation-in-part of application No. 09/975,215, filed on Oct. 10, 2001, now Pat. No. 6,502,421.
(63) Continuation-in-part of application No. 10/078,988, filed on Feb. 19, 2002, now Pat. No. 6,557,374.
(63) Continuation-in-part of application No. 10/024,079, filed on Dec. 17, 2001, now Pat. No. 6,560,991.

(51) Int. Cl. A62C 2/00; A62C 3/00; F25B 9/00; F25J 3/00

(52) U.S. Cl. 169/45; 169/46; 62/640

(57) ABSTRACT

A fire suppression system and a method for providing fire suppression onboard of an aircraft by rapidly establishing a breathable hypoxic atmosphere onboard of an aircraft, which can be generated by an air separation device utilizing a positive pressure of the bleed air and a negative pressure of the outside atmosphere; breathable hypoxic fire-extinguishing agent, containing 12%-18% of oxygen, can flood protected compartments of an aircraft in case of a fire and/or can be used as propellant for generating water mist or foam.

This invention is a continuation in part of U.S. Ser. No. 10/726737 “Hypoxic Aircraft Fire Prevention and Suppression System with Automatic Emergency Oxygen delivery System” and U.S. Pat. Nos.: 6,314,754; 6,334,315; 6,401,487; 6,418,752, 6,502,421, 6,557,374 and 6,560,991.

### SUMMARY OF THE INVENTION

This invention is based on the fact that hypoxic air can suppress fire while people can breathe and on the fact that an air separation membrane can produce several times more of hypoxic air with necessary O2 content (preferably 12%-14%) then it can produce nitrogen. Moreover, much lower feed air pressure is needed to produce such hypoxic air than nitrogen that cannot be used to extinguish fire in a passenger aircraft. Most of technologies utilize suppression principle for aircraft fires using chemical agents, but no one suggested the use of oxygen-enrichment membranes or other air-separation devices for suppression.

Further, this invention describes that multiple lightweight membranes or other air-separation devices (pressure-swing adsorption units, etc.) can produce rapidly necessary quantities of hypoxic air in order to flood the aircraft cabin and/or cargo compartment with hypoxic air, which will extinguish any fire at very beginning.

Furthermore, the invented design and method are based on the exposure of the oxygen outlet of an air separation device to the negative pressure of the outside atmosphere at aircraft cruise altitudes, which increases the productivity of the hypoxic air significantly. The productivity effect of such design will be the same as traditional design of an air separation device receiving feed air from a compressor and having a vacuum pump on the oxygen outlet. Though, the invented system utilizes engine's bleed air instead of compressor and the negative pressure of the outside atmosphere instead of a vacuum pump.

The lower operating pressure and exposure to the partial vacuum allows to effectively using lightweight air separation membranes or other devices in sizes and quantities necessary for producing fire-extinguishing hypoxic atmosphere within aircraft cabin within 1-3 minutes after detection of smoke or fire.

### DESCRIPTION OF THE INVENTION

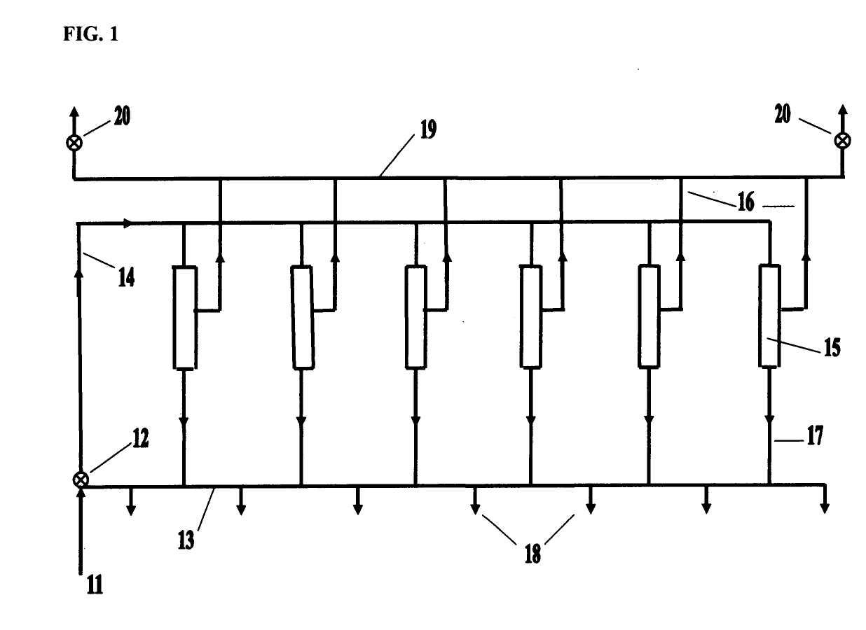

FIG. 1 describes schematically the main idea of this invention. Engine's bleed air from line 11 is normally supplied for the aircraft cabin ventilation through three-way valve 12 into line 13 being discharged further through nozzles 18 into aircraft cabin. In case of a fire emergency valve 12 is actuated closing line 13 and sending all available bleed air into line 14.

Multiple lightweight air-separation devices 15, preferably oxygen-enrichment membranes, are connected to line 14 with their inlet and receive bleed air under pressure from line 14. This causes a separation of bleed air into oxygen enrichment fraction and oxygen-depleted (hypoxic) fraction. Oxygen-enriched fraction is wasted from the system via outlets 16 into line 19 and hypoxic fraction is forwarded via conduits 17 into ventilation line 13 being further released into cabin via nozzles 18. This allows to rapidly establish hypoxic fire-extinguishing atmosphere inside of an aircraft cabin or other compartment having oxygen content from 12% to 16% depending on application (recommended is 14%-15%).

Oxygen-enriched waste gas is forwarded from outlets 16 into line 19 having one or more release valves 20 that, when open, allow the discharge of the waste gas into outside atmosphere. Valves 20 are optional and line 19 can be permanently open to the outside atmosphere if the design of the separation device 15 prevents air circulation in the opposite direction.

Bleed air is available on board of a modern passenger aircraft, such as Boeing 747, in large quantities, though at a limited pressure, which is still sufficient for a productive air separation by devices 15. The greatest advantage of the invented system is that when valves 20 are open, the vacuum suction effect of the outside atmosphere on cruise heights (about 10 km) is employed. This alone can double or triple the productivity of membranes (or other air separation devices) 15. In some applications, an independent compressed air source can be utilized instead of the bleed air from the aircraft engine. A compressor or a set of compressors or blowers can be installed onboard in order to feed the air separation system in a case of fire.

The principle of applying a vacuum pump on one of the outlets of an air separation membrane is known to those skilled in the art. A typical design comprises a compressor that drives air under pressure (usually about 100 bar) into such membrane for separation and a vacuum pump on an outlet allows to significantly increasing overall productivity and/or reduce compressor performance. However, no one before suggested the use of the reduced atmospheric pressure outside of an aircraft in order to significantly increasing the production of the hypoxic air. This alone allows reducing the number and weight of membranes 15 and achieving effective air separation even by employing a relatively low feed pressure of the bleed air on board of an aircraft.

Obviously, the invented system is quite unusual—no compressor and no vacuum pump being utilized. Membranes 15 can utilize low-pressure bleed air and the partial vacuum of the outside atmosphere, which makes the system work more efficiently—otherwise it would be impossible to achieve cost-effectively the fast flooding of the aircraft cabin with hypoxic air.

Additionally this design does not require strong shell around the membrane that can be made from lightweight composite material. Such high-flux membranes are available from FirePASS Corporation in New York. One of them is about 100 cm long and 15 cm in diameter weighting only about 4 kg. The productivity of this membrane in the above-described configuration is about 1 m3/min of hypoxic air.

The oxygen content in hypoxic fraction can reach form 10% to 15% depending on application, 12% O2 is preferred. It means that 50 of such membranes distributed along the cabin interior (e.g. behind the ceiling) would achieve the fire extinguishing atmosphere having 14%-16% O2 in a Boeing 747 cabin within 3-4 minutes. Actually, the flame will start diminish and will stop propagate when the O2 content drops below 18%, which may be achieved within 1-2 min. At altitudes over 3 km the extinguishing effect for class A,B and C fires can be achieved in the atmosphere containing 15%-17% of oxygen.

Once the desired oxygen content, for instance 15%, is achieved, the bleed air pressure or flow can be regulated by a computerized control the way that the oxygen content in the incoming hypoxic fraction will be also 15%. After the fire extinguished the oxygen content in the hypoxic fraction can be adjusted to 16% that will help to prevent reignition. If the fire source is located and neutralized the oxygen content in the cabin can be kept at a precautious level of 18% or the normal ventilation can be resumed. The invented system can be used as many times as needed and will never run out of the “suppression agent”.

During the initial stage of the fire suppression, a necessary amount of water mist or foam may be generated by using hypoxic fraction as propellant. The water mist or foam can be generated inside selected protected compartments of the aircraft by using necessary amounts of water or foam generating liquid. This method is described in the previous application U.S. Ser. No. 10/726737.

It is also possible to build special long (10-20 m) membranes that would produce each 10-20 m3/min of hypoxic air—the bigger the length of a membrane, the better the separation factor.

The fire extinguishing atmosphere on board of a passenger aircraft having oxygen content of 14% may provide discomfort to some passengers; therefore some of the oxygen enriched waste from line 19 should be supplied to passengers for respiration via masks. This can be easily achieved by installing a vacuum pump that in emergency will draw necessary amount of the oxygen reach waste for delivery to passengers. The advantage of such emergency oxygen supply is that it can last for as long as needed compare to the oxygen supply from onboard bottles.

Obviously, any other air separation device can be used instead of the oxygen-enrichment membrane 15. Flat oxygen permeable membranes, Pressure-Swing and Temperature-Swing Adsorption devices can be utilized as well.

Flat oxygen permeable membranes can be used in airspace applications in order to rapidly lower the oxygen content in the internal atmosphere of an aircraft or space vehicle. Flat membranes can be incorporated in the wall structure of the aircraft so that, when needed, they can be exposed to the vacuum outside of the air- or spacecraft. In this case such flat membranes will allow oxygen molecules through while blocking nitrogen molecules from leaving the internal atmosphere. This way the oxygen content can be rapidly lowered in an emergency situation. Controlled exposure will allow to keeping oxygen content at a safe level (for instance, from 12% to 18%). This design does not require any bleed air and can be utilized for space craft and other airspace applications.

The use of a permanent fire-extinguishing hypoxic atmosphere for fire prevention was described in the previous application U.S. Ser. No. 10/726737. Though, the main subject of this invention is a safe and a rapid creation of the hypoxic atmosphere for fire suppression, since it would be uncomfortable for passengers to be exposed to hypoxic atmosphere all the time during the flight.

This invention can resolve completely the most complex problem of the fire emergency landing since an aircraft flooded with such breathable hypoxic fire-extinguishing atmosphere can continue its flight for hours to its destination or until an acceptable landing airport found.

1. A fire suppression system and a method for providing fire suppression onboard of an aircraft by rapidly establishing a hypoxic atmosphere onboard of an aircraft by utilizing a positive pressure of the bleed air and a negative pressure of the outside atmosphere, said system comprising:
an air separation device having a bleed air inlet, a product outlet and a waste outlet;
said inlet receiving pressurized bleed air from the aircraft engine, which is further separated into an oxygen-enriched fraction and a hypoxic fraction in said separation device;
said oxygen-enriched fraction being wasted trough said waste outlet that is exposed to a negative pressure of the outside atmosphere at the aircraft altitude, which significantly induces productivity of said separation device;
said hypoxic fraction being discharged, in case of a fire emergency, through said product outlet into said aircraft compartment in order to reducing the oxygen content in its internal atmosphere to a level between 12% and 18% and providing a safe fire extinguishing environment that can be maintained for hours during the rest of the flight.

2. The invention according to the claim 1 wherein:
said air separation device consisting of multiple interconnected air-separation units being used as one system for producing sufficient quantities of the hypoxic fraction.

3. The invention according to the claim 1 wherein:
said air separation device employing membrane air separation technology.

4. The invention according to the claim 1 wherein:
said air separation device employing pressure swing-adsorption technology.

5. The invention according to the claim 1 wherein:
said product outlet communicating with the cabin ventilation system and delivering said hypoxic fraction through the multiple outlets of the ventilation system.

6. A method of a rapid providing of a breathable fire-suppressive atmosphere onboard of an aircraft, said method comprising:
use of compressed atmospheric air in an air separation system for generating hypoxic gas mixture; said system having a hypoxic product outlet and an oxygen-enriched fraction outlet;
exposure of said oxygen-enriched fraction outlet to the negative pressure of the outside atmosphere at the aircraft altitude, in order to significantly increasing the productivity of said separation system;
said hypoxic product outlet communicating with the aircraft interior and transmitting said hypoxic gas mixture;
said system, being activated in case of a fire emergency, flooding the protected aircraft compartments with said hypoxic gas mixture and establishing a breathable fire-extinguishing atmosphere onboard for as long as needed;
said breathable fire-suppressive atmosphere having oxygen content from 12% to 18% depending on the aircraft altitude.

7. The method of claim 6 wherein
said system consists of multiple air separation devices connected together in order to provide sufficient quantities of the hypoxic gas mixture for rapid establishing of the fire-extinguishing atmosphere.

8. The method of claim 6 wherein
said protected compartments may include passenger cabin, cargo compartments, fuel tanks and other compartments of an aircraft.

9. The method of claim 6 wherein
said hypoxic gas mixture being used as propellant for generating water mist or foam inside selected protected compartments by using necessary amounts of water or foam generating liquid.

10. The method of claim 6 wherein said compressed atmospheric air being bleed air supplied by an aircraft engine.

11. The method of claim 6 wherein said compressed air being supplied by an independent compressor or a set of multiple compressors or blowers.

12. The method of the claim 6 wherein a part of said oxygen enriched fraction being send to passengers respiratory masks for inhalation during an emergency. Said fraction may contain oxygen in a range from 30% to 90%.

13. A method of a rapid creation of a breathable fire-suppressive atmosphere onboard of a space vehicle, said method comprising:
a controlled exposure of oxygen permeable membranes to a negative pressure or vacuum outside of the vehicle in order to rapidly depleting the internal atmosphere of oxygen to a level from 12% to 18%.
